(19) United States
(12) Patent Application Publication
(10) Pub. No.: US 2008/0142755 A1
(43) Pub. Date: Jun. 19, 2008

(54) Heater apparatus and associated method

(75) Inventors: Balasubramaniam Vaidhyanathan, Bangalore (IN); Salil Mohan Joshi, Mumbai (IN); Sheela Kollali Ramasesha, Bangalore (IN); Mamatha Nagesh, Bangalore (IN); Victor Lienkong Lou, Schenectady, NY (US); George Theodore Dalakos, Niskayuna, NY (US); Michael John Wittbrodt, Niskayuna, NY (US); Dalong Zhong, Niskayuna, NY (US)

Correspondence Address: MOMENTIVE PERFORMANCE MATERIALS INC.-Quartz;c/o DILWORTH & BARRESE, LLP, 333 Earle Ovington Blvd., Uniondale, NY, 11553, US

(73) Assignee: General Electric Company, Schenectady, NY (US)

(21) Appl. No.: 11/638,022

(22) Filed: Dec. 13, 2006

(51) Int. Cl. C09K 5/00; H05H 1/24; H05B 3/28

(52) U.S. Cl. 252/71; 427/576; 264/614; 219/444.1

(57) ABSTRACT

A wafer processing apparatus, including a heater apparatus, is provided. The heater apparatus includes a coating layer; and a seal structure in contact with the coating layer. The seal structure is formed from a seal formable material. The seal formable material includes at least one of a YASB glassy composition, a CGYP glassy composition, or a combination of the YASB glassy composition and the CGYP glassy composition. A method and device are also included.

### BACKGROUND

1. Technical Field

The invention includes embodiments that relate to a wafer processing apparatus such as a heater. The invention includes embodiments that relate to methods of making and using the wafer supporting apparatus.

2. Discussion of Related Art

Silica is sometimes used in semi-conductor wafer fabrication. Silica is susceptible to etching by halogens, and particularly susceptible at operating temperatures. The useful life of a silica component may be limited by halogen corrosion. Aluminum oxide and aluminum nitride may be relatively more resistant to halogen etching than silicon oxide, and they are used in some applications.

Currently available aluminum-based materials can be polycrystalline, and therefore have grain boundaries. The etch rate at the grain boundary may be different from the etch rate of the grain body. The differing etch rates may allow for particle generation or dust production that may undesirably contaminate work products.

U.S. Pat. No. 5,462,603 discloses a CVD apparatus for use in semiconductor wafer processing having a cylindrical case made of quartz glass. US Patent Publication No. 20060199131A1 support a wafer processing apparatus having a heat-resistant, opaque quartz cover disposed under the lower surface of the support table. JP Patent Publication No. 2001244057 discloses a ceramic heater for wafer heating apparatus, with a insulating glass layer formed on silicon oxide layer, over which heating resistor and plate shaped silicon carbide layers are formed.

It is desirable to have materials for use in wafer fabrication that have relatively improved properties and characteristics, such as a lower etch rate or ease of application, relative to currently available materials. It may be desirable to have an article and/or system for use in wafer fabrication that has relatively improved properties and characteristics, such as a longer useful life, relative to currently available articles and systems.

### BRIEF DESCRIPTION

According to an embodiment of the invention, a wafer processing apparatus is provided. The wafer processing includes a coating layer; and a seal structure in contact with the coating layer. The seal structure is formed from a seal formable material. The seal formable material includes at least one of a YASB glassy composition, a CGYP glassy composition, or a combination of the YASB glassy composition and the CGYP glassy composition.

In one embodiment, a method is provided that includes forming a seal structure on a coating layer of a wafer processing apparatus from a seal formable material. The seal formable material includes at least one of a YASB glassy composition, a CGYP glassy composition, or a combination of the YASB glassy composition and the CGYP glassy composition.

In one embodiment, a wafer processing apparatus comprising a heat-generating device is provided. The heat-generating device includes a heating element substrate, a coating layer disposed on a surface of the substrate, and means for sealing the coating layer to reduce etching of the substrate during operation, during cleaning, or during both operation and cleaning.

### BRIEF DESCRIPTION OF DRAWING FIGURES

FIG. 1 is a schematic cross-sectional view of an article comprising an embodiment of the invention.

FIG. 2 is a schematic cross-sectional view of an article comprising an embodiment of the invention.

### DETAILED DESCRIPTION

The invention includes embodiments that relate to a wafer processing apparatus. The invention includes embodiments that relate to methods of making and using the heater apparatus.

Approximating language, as used herein throughout the specification and claims, may be applied to modify any quantitative representation that could permissibly vary without resulting in a change in the basic function to which it is related. Accordingly, a value modified by a term or terms, such as “about”, are not to be limited to the precise value specified. In some instances, the approximating language may correspond to the precision of an instrument for measuring the value.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity can not occur—this distinction is captured by the terms “may” and “may be”.

As used herein, reference to lanthanide includes yttrium. And, examples of yttrium are interchangeable with other lanthanides unless the species is inoperable, or context or language indicates otherwise. As used herein, reference to alkaline earth metal includes calcium and strontium. And, examples of calcium and strontium are interchangeable with other alkaline earth metals unless the species is inoperable, or context or language indicates otherwise.

As used herein, the term “seal structure” refers to an overall protector, e.g., coating layer that seals or protects the underlying substrate coated by the layer, an encapsulating layer or structure that protects the underlying structure or assembly, or a seal member/sealant that seals gaps, cracks, contact entries between a functional member of a heater apparatus and the substrate or the coating layer. In one embodiment, the seal structure defines and seals an aperture through which an electrode or an electrical lead is disposed.

As used here, “seal formable material” refers to the composition comprising the “seal structure.”

As used herein, “functional members” of a wafer processing apparatus include but are not limited to, holes, tabs on the edge of the wafer processing apparatus, contacts to the electrode, or inserts in the substrate to meet functional requirements of the wafer processing apparatus.

As used herein, “a wafer processing apparatus” refers to an assembly comprising at least one of a substrate holder, a susceptor, a support table, a heater, or an electrostatic chuck for use in a wafer processing chamber. In one embodiment, the wafer processing apparatus refers to a heater, which typically contains at least one heating element to heat the wafer. In another embodiment, the apparatus refers to an electrostatic chuck (ESC), which comprises at least one electrode for electro-statically clamping the wafer; or a heater/ESC combination, which has electrodes for both heating and clamping. Also used herein, the term “wafer processing apparatus” may be used interchangeably with a “heater apparatus,” refering to an apparatus for use in semi-conductor processing environment and exposed to the highly corrosive environment in the CVD processes.

Materials that form stable halides with high vaporization temperatures may resist etching by halogen. As the stable-halide forming material contacts the halide the reaction product forms a layer that may protect the reaction product layer from further attack. For example, fluorides of alkaline earths, Al, Ga, Y, Zr, Hf and lanthanides are non-volatile, and materials containing these elements are resistant to halogen etching. Mixed oxide glassy compositions, containing, for example, aluminum oxide and yttrium oxide, can form an etch resistant structure. According to embodiments disclosed herein, such halogen resistant glasses are referred to as YASB glassy compositions and CGYP glassy compositions, and can be used as sealing materials. In alternative embodiments, additional glass former additive can be added. The amounts, ratios, and preparation of these glasses may affect the amount or degree of protection offered, or the amount of etch resistance available. These and other additives can be used to affect and control other features and attributes of the article formed therefrom. These features and attributes can include, for example, residual stress, coefficient of thermal expansion, transparency or translucency, cost, electrical and thermal properties, and the like.

In one embodiment, a heater apparatus includes a coating layer and a seal structure in the form of an encapsulating layer or housing in contact with the coating layer. The seal structure is formed from a seal formable material comprising at least one of the YASB glassy composition, the CGYP glassy composition, or a combination of the YASB glassy composition and the CGYP glassy composition. In another embodiment, the seal structure is in the form of an overcoating layer.

In one embodiment, the YASB glassy composition can be the reaction product of yttrium oxide, aluminum oxide, boron oxide, and silica. The CGYP glassy composition can be the reaction product of at least one of calcium oxide or strontium oxide; and at least one of gallium oxide or aluminum oxide or yttrium oxide; and ammonium phosphate; and silica.

In one embodiment, the YASB glassy composition includes at least one material having a molar oxide percentage selected from the group consisting of Y₂Al₂BSi₅O_{17.5}; Y_{1.6}Al_{2.2}BSi_{5.2}O_{17.6}; YAl₂BSi₆O₁₈; Y_{0.6}Al_{2.2}BSi_{6.2}O_{18.1}; Y₂AlBSi₆O₁₈; and, Y_{1.6}Al_{1.2}BSi_{6.2}O_{18.1}. In another embodiment, the YASB glassy composition consists essentially of Y₂Al₂BSi₅O_{17.5}. In yet another embodiment, the YASB glassy composition consists essentially of Y_{1.6}Al_{2.2}BSi_{5.2}O_{17.6}. In one embodiment, the YASB glassy composition consists essentially of YAl₂BSi₆O₁₈. In one embodiment, the YASB glassy composition consists essentially of Y_{0.6}Al_{2.2}BSi_{6.2}O_{18.1}. In one embodiment, the YASB glassy composition consists essentially of Y₂AlBSi₆O₁₈. In one embodiment, the YASB glassy composition consists essentially of Y_{1.6}Al_{1.2}BSi_{6.2}O_{18.1}.

In one embodiment, suitable CGYP glassy compositions are represented by the formula (AB)₂(P,Si)₃O₁₂ where AB is one or more alkaline earth metals. In one embodiment, the CGYP glassy composition is represented by the formula:

Ca_{ε}SR_{2-ε}Ga_{ψ}Al_{α}Y_{β}P₂SiO₁₂

where: 0≦ε≦2; ψ+α+β=2. Another method of identifying suitable species falling within the scope of CGYP glassy compositions includes those materials having the formula: (Ca,Sr)₂(Ga,Al,Y)₂(P,Si)₃O₁₂.

In one embodiment, the CGYP glassy composition includes at least one material selected from the group consisting of CaSrGaAlP₂SiO₁₂; CaSrAlYP₂SiO₁₂; CaSrAl_{1.25}Y_{0.75}P₂SiO₁₂; CaGa₂P₂SiO₁₂; CaSrGa₂P₂SiO₁₂; CaSrAl2P₂SiO₁₂; CaSrY₂P₂SiO₁₂; Ca₂Y₂P₂SiO₁₂; Ca₂AlYP₂SiO₁₂; and, CaSrAl_{0.5}Y_{1.5}P₂SiO₁₂.

In one embodiment, the CGYP glassy composition consists essentially of CaSrGaAlP₂SiO₁₂. In one embodiment, the CGYP glassy composition consists essentially of CaSrAlYP₂SiO₁₂. In one embodiment, the CGYP glassy composition consists essentially of CaSrAl_{1.25}Y_{0.75}P₂SiO₁₂. In one embodiment, the CGYP glassy composition consists essentially of Ca₂Ga₂P₂SiO₁₂. In one embodiment, the CGYP glassy composition consists essentially of CaSrGaₛP₂SiO₁₂. In one embodiment, the CGYP glassy composition consists essentially of CaSrAl2P₂SiO₁₂. In one embodiment, the CGYP glassy composition consists essentially of CaSrY₂P₂SiO₁₂. In one embodiment, the CGYP glassy composition consists essentially of Ca₂Y₂P₂SiO₁₂. In one embodiment, the CGYP glassy composition consists essentially of Ca₂AlYP₂SiO₁₂. In one embodiment, the CGYP glassy composition consists essentially of CaSrAl_{0.5}Y_{1.5}P₂SiO₁₂.

In one embodiment, if a combination of YASB and CGYP is used, the combination of the YASB glassy composition and the CGYP glassy composition has a ratio of the YASB glassy composition to the CGYP glassy composition is greater than about 0.05:1. In another embodiment, the combination of the YASB glassy composition and the CGYP glassy composition has a ratio of the YASB glassy composition to the CGYP glassy composition is less than about 500:1. In other embodiments, suitable ratios can be in any of the following ranges: from about 0.05:1 to about 0.5:1, from about 0.5:1 to about 1:1, from about 1:1 to about 5:1, from about 5:1 to about 10:1, from about 10:1 to about 50:1, from about 50:1 to about 100:1, or from about 100:1 to about 500:1.

In one embodiment, the seal formable material has a softening temperature that is greater than about 650 degrees Celsius as measured by a dilatometer at a pressure of about 60 centiNewtons on an area of about 6 millimeters square to about 15 millimeters square. In one embodiment, the seal formable material has a softening temperature that is less than about 1000 degrees Celsius as measured by a dilatometer at a pressure of about 60 centiNewtons on an area of about 6 millimeters square to about 15 millimeters square. In one embodiment, the softening temperature is in any of the following ranges: from about 500 degrees Celsius to about 650 degrees Celsius, from about 650 degrees Celsius to about 750 degrees Celsius, from about 750 degrees Celsius, from about 750 degrees Celsius to about 850 degrees Celsius, from about 850 degrees Celsius to about 950 degrees Celsius, or from about 950 degrees Celsius to about 1050 degrees Celsius.

The melt temperature can be used to characterize and identify suitable compositions for use in embodiments of the invention. In one embodiment, the seal formable material has a melt temperature that is less than a melt temperature of the coating layer. In another embodiment, the melt temperatures is greater than about 800 degrees Celsius. In other embodiments, the melt temperature can be in any of the following ranges: from about 750 degrees Celsius to about 850 degrees Celsius, from about 850 degrees Celsius to about 950 degrees Celsius, from about 950 degrees Celsius to about 1050 degrees Celsius, from about 1050 degrees Celsius to about 1150 degrees Celsius, or from about 1150 degrees Celsius to about 1250 degrees Celsius.

In one embodiment, the seal formable material has a linear coefficient of thermal expansion (CTE) that is greater than about 3.3 and less than about 11. In other embodiments, the coefficient of thermal expansion can be in any of the following ranges: from about 3 to about 4, from about 4 to about 5, from about 5 to about 6, from about 6 to about 7, from about 7 to about 8, from about 8 to about 9, or from about 9 to about 10. In one embodiment, the coefficient of thermal expansion is about 4.4. In one embodiment, the coefficient of thermal expansion is about 5.7. In one embodiment, the coefficient of thermal expansion is about 6. In one embodiment, the seal formable material has a coefficient of thermal expansion that is in a range of from about 4.4 to about 5.7.

The seal formable material may be applied as a slurry or as a powder. If a slurry, the carrier fluid may include water or may consist essentially of water. Other suitable carrier fluids for use as a slurry include organic solvents that have a reduced level of reactivity with the seal formable material, a relatively low ash content, and a relatively high vapor pressure/high volatility. Non-limiting examples of organic solvents may include short-chain alcohols such as methanol, ketones, and the like. In one embodiment, the carrier fluid may include silicone fluid, siloxane precursors, or silane materials that may form a part of the seal structure interface.

In one embodiment, the seal structure formed from the seal formable material may have an etch rate of less than 6 Angstroms/minute in an oxidizing environment of 18 percent oxygen and the balance being CF₄ plasma at room temperature for 12 hours. In one embodiment, the seal formable material may have an etch rate of less than 6 Angstroms/minute in a nitrogenous environment comprising a plasma mixture of NF₃ (14.29 percent) and Ar (42.86 percent) and nitrogen (N₂) (42.86 percent) at 400 degrees Celsius for 60 minutes. The etch rate may be in a range of from about 6 Angstroms/minute to about 5 Angstroms/minute, from about 5 Angstroms/minute to about 4 Angstroms/minute, or less than about 4 Angstroms/minute in the oxidizing environment and/or the nitrogenous environment.

In some embodiments, depending on the harsh environment and operating temperatures, the seal structure may have an etch rate of less than 100 Angstroms per minute, in a range of from about 100 Angstroms per minute to about 75 Angstroms per minute, from about 75 Angstroms per minute to about 50 Angstroms per minute, from about 50 Angstroms per minute to about 25 Angstroms per minute, from about 25 Angstroms per minute to about 15 Angstroms per minute, from about 15 Angstroms per minute to about 10 Angstroms per minute, from about 10 Angstroms per minute to about 5 Angstroms per minute, from about 5 Angstroms per minute to about 2 Angstroms per minute, from about 2 Angstroms per minute to about 1 Angstrom per minute, from about 1 Angstrom per minute to about 0.5 Angstroms per minute, from about 0.5 Angstrom per minute to about 0.1 Angstroms per minute or less than about 0.1 Angstroms per minute. In one embodiment, the rate of etching is less than about 10 Angstroms/minute at a temperature that is greater than room temperature.

In some embodiments, the seal structure includes an amorphous phase, crystalline phase, or be engineered to be a mixture of both amorphous and crystalline phases. The thickness of the seal structure can be selected with reference to the end-use application and the heater apparatus configuration. In some embodiments, the seal structure has a thickness less than about 1 millimeter. In one embodiment, the thickness is in any of the following ranges: from up to about 100 micrometers to about 500 micrometers, from about 500 micrometers to about 600 micrometers, from about 600 micrometers to about 750 micrometers, or from about 750 micrometers to about 1000 micrometers. In one embodiment, the thickness may be in a range of from about 1 millimeter to about 5 millimeters, from about 5 millimeters to about 10 millimeters, from about 10 millimeters to about 50 millimeters, from about 50 millimeters to about 75 millimeters, or the thickness may be greater than about 75 millimeters.

In one embodiment, the seal structure has a residual stress value (either tensile or compressive) that is greater than or equal to about 10 megapascal (MPa). In another embodiment, the residual stress may be greater than about 100 MPa (compressive) or greater than about 200 MPa (compressive). The coating may have a mechanical strength at a temperature in a range of from about room temperature and up to more than 1000 degrees Celsius that is characterized by a bending strength or a fracture toughness. The bending strength may be at least 1100 MPa at room temperature and at least 850 MPa at 1000 degrees Celsius. The fracture toughness (KIC) may be greater than 6.5 MPa.m² at room temperature and greater than about 5 MPa.m² at 1000 degrees Celsius.

In one embodiment, the coating layer is disposed on a surface of a substrate. Suitable substrates may include at least one of pyrolitic boron nitride, aluminum nitride, quartz or doped quartz, a metal or metal alloy, or another glassy composition. With regard to the substrate glassy composition, it may be substantially the same as the seal formable material but having a relatively higher melt temperature and/or softening temperature. In one embodiment of a ceramic core heater, the base substrate comprises an electrically insulating material (e.g., a sintered substrate) selected from the group of oxides, nitrides, carbides, carbonitrides, and oxynitrides of elements selected from a group consisting of B, Al, Si, Ga, Y, refractory hard metals, transition metals; and combinations thereof. In another embodiment, the heater comprises a core substrate comprising graphite. In yet another embodiment, other electrically conductive materials may be used for the core substrate, including but not limited to refractory metals such as W and Mo, transition metals, rare earth metals and alloys; oxides and carbides of hafnium, zirconium, and cerium, and mixtures thereof In other embodiments, the heater comprises a metal substrate made of a high temperature material, e.g., copper or aluminum alloy such as A6061.

In one embodiment, a suitable substrate includes one or more of a metal nitride, a metal carbide, a metal boride, a metal oxide, or graphite. The metal nitride may be boron nitride. The boron nitride may be carbon doped. In an exemplary embodiment, the metal nitride may be pyrolitic boron nitride. The metal nitride may include one or more of beryllium, chromium, hafnium, lanthanum, magnesium, molybdenum, niobium, silicon, tantalum, titanium, tungsten, vanadium, or zirconium. The metal nitride may include silicon nitride. The metal carbide may include one or more of beryllium, chromium, hafnium, lanthanum, magnesium, molybdenum, niobium, silicon, tantalum, titanium, tungsten, vanadium, or zirconium. The metal boride may include one or more of beryllium, chromium, hafnium, lanthanum, magnesium, molybdenum, niobium, silicon, tantalum, titanium, tungsten, vanadium, or zirconium. The metal oxide may include one or more of beryllium, chromium, hafnium, lanthanum, magnesium, molybdenum, niobium, silicon, tantalum, titanium, tungsten, vanadium, or zirconium. In one embodiment, the substrate may include one or more of silicon nitride, silicon carbide, or quartz. In one embodiment, the substrate may include two or more of the above compounds.

The substrate shape and size may depend on the particular end-use application. The substrate may include a single layer, or may include multiple layers. The multiple layers may be formed from either same material; or, differing materials from layer to layer. The different layers, for example, may have differing electrical and thermal properties.

After formation, the seal structure forms a glass-to-glass seal to the coating layer and/or the substrate. The seal so formed may have an adhesive strength that is greater than about 300 pounds per square inch (psi). In one embodiment, the adhesive strength is in a range of from about 100 psi to about 200 psi, from about 200 psi to about 300 psi, from about 300 psi to about 400 psi, or greater than about 400 psi.

In one embodiment, the seal structure defines an aperture through which an electrode or an electrical lead is disposed. An electrical lead provides electrical communication for a heater element. disposed in the heater apparatus to a power source and/or controller located outside of the heater apparatus. Thus, electrical power may be supplied into the heater apparatus to an electrically resistive heater electrode while the seal structure may keep deleterious gas and vapor from negatively affecting the substrate and/or electrode within the heater apparatus.

The electrode mentioned may be a heater element, an electrostatic chuck, or a thermocouple. Further, the seal structure may further be bonded or adhered to an outer surface of the electrode to seal thereto. Suitable heater elements may include carbon, molybdenum, nickel, and the like. In one embodiment, the heater element is nickel-plated molybdenum. The electrode may be one of a plurality of electrodes. At least two of the electrodes may be heater elements, and each of the heater elements may define an independently or reparably controllable heat zone proximate to the heater apparatus.

In one embodiment, with regard to the amounts in the YASB glassy composition of the lanthanide (L), aluminum (A), silicon (S), and boron (B) the ratio of each relative to each other may be controlled to affect the end-use properties and characteristics. Such end-use properties and characteristics may be associated with the use to fit the use of the particular device, needs associated with the device. The amounts and ratios may be expressed in terms of the precursor amounts used in the formation of the glassy material. In one embodiment, the amounts are expressed as a ratio of L:A:S:M, where L is yttrium and M is boron, in terms of the weight percent of the oxide precursors and may be selected from about: 20:20:40:20; 40:20:35:5; 40:20:30:10; 45:15:20:20; 35:20:30:15; 40:15:35:10; 50:25:25; and 10:25:35:30.

In another suitable quaternary system the amounts are expressed as a ratio of L:A:S:M, where L is yttrium and M includes boron and one or both of cerium and gadolinium, in terms of the weight percent of the oxide precursors and may be selected from about: 20:20:40:20; 40:20:35:5; 40:20:30:10; 45:15:20:20; 35:20:30:15; 40:15:35:10; 50:25:25; and 10:25:35:30.

In one embodiment, with regard to the amounts in the CGYP glassy composition of the alkaline earth metal (C), gallium or aluminum or yttrium (GY), and phosphorus or silicon oxide (P) the ratio of each relative to each other may be controlled to affect the end-use properties and characteristics. Such end-use properties and characteristics may be associated with the use to fit the use of the particular device, needs associated with the device. The amounts and ratios may be expressed in terms of the precursor amounts used in the formation of the glassy material.

A suitable quaternary system may include amounts of the oxide precursors, separately, that are in a range of from about 20 weight percent to about 50 weight percent of yttrium oxide, from about 15 weight percent to about 25 weight percent of aluminum oxide, from about 30 weight percent to about 40 weight percent silicon dixoide, and at least one of cerium oxide, gallium oxide, gallium nitride, or gadolinium oxide that is present in an amount in a range of from about 20 weight percent to about 50 weight percent of yttrium oxide. Also included are formulations for more than four-component glass materials.

In one embodiment, additives may be used as glass formers and/or sintering aids. Suitable glass formers may include, for example, boron, phosphorus, or germanium. In some embodiments, the additives may include phosphorus and/or boron. In one embodiment, the seal forming composition is a quaternary system, e.g., YASB or CGYP.

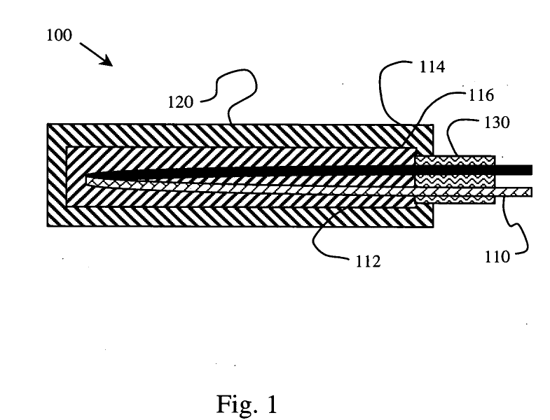

With reference to FIG. 1, an article 100 comprising an embodiment of the invention is shown. The article may be used as a heater in a wafer processing apparatus or in semiconductor manufacture. A heating element 110 extends through a substrate 112. A coating layer 114 encapsulates the substrate and covers a surface 116 of the substrate at an interface. The coating layer is adhered to the substrate surface by at least one of chemical bonding or mechanical bonding. An outward facing surface 120 of the coating is configured for exposure to a harsh environment during use. A seal structure 130 is disposed between, and in adhesive contact with, the heating element and the coating layer. The harsh environment can include halogens and/or oxidants at elevated temperatures. Suitable halogens can include one or more of chlorine, fluorine, bromine, and gaseous iodine. In one embodiment, the halogen is fluorine. The harsh environment may be a plasma. In one embodiment, a harsh environment contains ammonia or hydrogen; and, may be at an elevated temperature.

In one embodiment, the harsh environment is a corrosive environment, and may include one or more etchants, such as halogen-containing etchants. Examplary etchants include, for example, nitrogen trifluoride (NF₃) or carbon tetrafluoride (CF₄). Such a harsh environment may be associated with one or more of plasma etching, reactive ion etching, plasma cleaning, or gas cleaning. Examples of working environments may include halogen-based plasmas, halogen-based radicals generated from a remote plasma source, halogen-based species decomposed by heating, halogen-based gases, oxygen plasmas, oxygen-based plasmas, or the like. Examples of halogen-based plasma include a nitrogen trifluoride (NF₃) plasma, or fluorinated hydrocarbon plasma (e.g. carbon tetrafluoride (CF₄)), and may be used either alone or in combination with oxygen. The working environment may be a reactive ion etching environment.

In one embodiment of a working environment, temperature ranges can be greater than 10 degrees Celsius. In one embodiment, the working or operational temperatures may be in a range of from about 100 degrees Celsius to about 500 degrees Celsius, from about 500 degrees Celsius to about 750 degrees Celsius, from about 750 degrees Celsius to about 800 degrees Celsius, from about 800 degrees Celsius to about 850 degrees Celsius, from about 850 degrees Celsius to about 900 degrees Celsius, from about 900 degrees Celsius to about 1000 degrees Celsius, from about 1000 degrees Celsius to about 1100 degrees Celsius, from about 1100 degrees Celsius to about 1200 degrees Celsius, from about 1200 degrees Celsius to about 1100 degrees Celsius, from about 1100 degrees Celsius to about 1400 degrees Celsius, from about 1400 degrees Celsius to about 1500 degrees Celsius, or greater than about 1500 degrees Celsius. The working or operational temperature may be achieved by a slow ramp or a fast ramp, the cool down can be slow or may be a quick quench, and there may be multiple heat cycles during use depending on the end-use application.

In one embodiment, the heating element may include an electrically resistive heater material. A heating element defines a path through the body of the substrate that can be serpentine, a spiral, or a helix. Suitable materials for use in forming the heating element include one or more of molybdenum, tungsten, or ruthenium. In one embodiment, the heating element includes graphite. The heating element may function as an electrode or an electrically resistive heater.

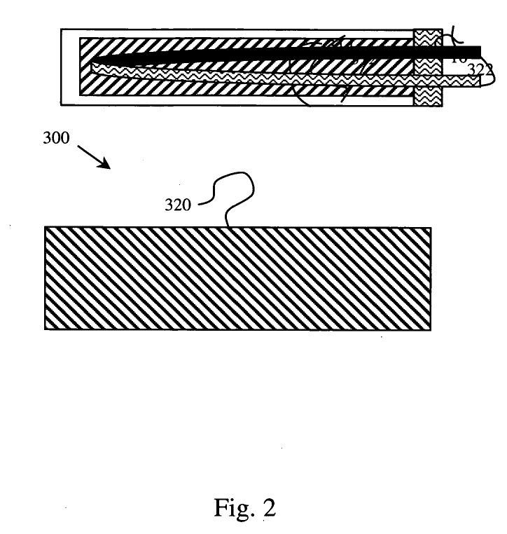

With reference to FIG. 2, an article 300 comprising an embodiment of the invention is shown. The article 300 includes a heating element 310 disposed within a substrate 312. The substrate is sized and shaped to be received within a volume defined by a inner surface of a casing 314 and through an open end. The outer surface 316 of the substrate may contact with, but is not necessarily adhered to, an inner surface of the casing. An outer surface 320 of the casing may be exposed to the harsh environment during use. A seal structure 322 according to an embodiment of the invention encapsulates the heating element ends or leads that extend therethrough, and seals the substrate within the casing. The seal forming glassy compositions may be fabricated into the seal structure after the heating apparatus has been partially assembled.

### EXAMPLES

The following examples are intended only to illustrate methods and embodiments in accordance with the invention, and as such should not be construed as imposing limitations. Unless specified otherwise, all ingredients are commercially available from such common chemical suppliers as Alpha Aesar, Inc. (Ward Hill, Mass.), Spectrum Chemical Mfg. Corp. (Gardena, Calif.), and the like.

### Example 1

### Preparation and Test

Samples 1-5 are prepared. Samples 1-5 include oxide powders mixed in the proportions set forth in Tables 1-2. The powders are weighed, mixed, and melted at temperatures greater than about 1500 degrees Celsius to achieve a fully molten homogeneous mass. The glass samples are made by melting the oxide mix at 1650° C. and quenching the melt between two heavy stainless steel plates to form Pucks 1-5.

TABLE 1
Ingredients for Samples 1–5. >molar % of cations.

| Sample # | Y | Ce | Gd | Al | Si | total |
|---|---|---|---|---|---|---|
| 1 | 28.6 | — | — | 28.6 | 42.9 | 100 |
| 2 | — | — | 28.6 | 28.6 | 42.9 | 100 |
| 3 | 12 | — | — | 40 | 48 | 100 |
| 4 | — | 12 | — | 40 | 48 | 100 |
| 5 | — | — | 12 | 40 | 48 | 100 |

TABLE 2
Weight (g) of oxides used to meet molar ratios.

| Sample # | Y₂O₃ | CeO₂ | Gd₂O₃ | Al₂O₃ | SiO₂ | total |
|---|---|---|---|---|---|---|
| 1 | 20 | — | — | 20 | 60 | 100 |
| 2 | — | — | 20 | 20 | 60 | 100 |
| 3 | 8.1 | — | — | 27 | 64.9 | 100 |
| 4 | — | 15 | — | 25 | 60 | 100 |
| 5 | — | — | 8.1 | 27 | 64.9 | 100 |

*Y = yttrium, Gd = gadolinium, Ce = cerium, Al = aluminum, Si = silicon (cation at %).

The glassy masses of Pucks 1-5 tested. Pucks 1-5 are each analyzed by two different tests: thermal mechanical analysis (TMA) and reactive ion etch test. The Pucks 1-5 are then further tested for coefficient of thermal expansion values.

Thermal mechanical analysis is performed in expansion mode on a TMA Q400 Thermo Mechanical Analyzer from TA Instruments, Inc. Experimental parameters were set at: 0.0500 Newtons of force, 5.000 grams static weight, nitrogen purge at 50.0 mL/min, and 0.5 sec/pt sampling interval. The samples are analyzed from ambient to 700 degrees Celsius then cooled to ambient at a 5 degrees Celsius per minute ramp rate for the number of cycles shown on the thermogram.

The reactive ion etch test (RIE test) parameters include NF₃/Ar (16/34 standard cubic centimeter per minute (sccm),) 100 mTorr, 400 W, 100 minutes. The results are listed in Table 2. Comparative Samples C-1 and C-2 are uncoated, untreated, standard silicon dioxide (SiO₂) wafers. The results are listed in Tables 3-4.

TABLE 3
RIE test results of Samples 1–5

gravimetric
Etch rate

| Sample | Å/min | (+/−) |
|---|---|---|
| C-1 | 448.6 | 0.7 |
| C-2 | 451.8 | 0.7 |
| 1 | 2.6 | 0.7 |
| 2 | 0.9 | 0.5 |
| 3 | 0.8 | 0.6 |
| 4 | 7.6 | 0.7 |
| 5 | 1.7 | 0.6 |

TABLE 4
Measured CTE of samples 1–5.

| Sample | CTE, ppm/° C. |
|---|---|
| 1 | 5.9 |
| 2 | 6.3 |
| 3 | 4 |
| 4 | 4.3 |
| 5 | 4.3 |

Temperature calibration is performed with an indium standard at a 5° C./min ramp rate under nitrogen purge. The CTE measurements are performed at 3° C./min, calibrated using a correction file from a CTE measurement run on polycrystalline alumina rod that is 2.5 cm in length.

Inspection of the samples after testing shows that fluorine is mainly associated with metal fluorides. That is, the halogen interaction forms YF₃ and GdF₃.

### Example 2

### Sample Preparation

Five test pucks 1-5 of Samples 6-10 are prepared containing amounts of alkaline earth metal, gallium or aluminum or yttrium, silicon oxide, and phosphorus. The compositions are listed in molar ratio form in Table 5. The pucks are prepared in the same manner as Example 1.

TABLE 5
Ratio of oxides used to meet molar ratios.

| Sample | Composition |
|---|---|
| 6 | CaSrGaAlP₂SiO₁₂ |
| 7 | CaSrAlYP₂SiO₁₂ |
| 8 | Ca₂Ga₂P₂SiO₁₂ |
| 9 | Ca₂Y₂P₂SiO₁₂ |
| 10 | CaSrAl_{0.5}Y_{1.5}P₂SiO₁₂ |

Testing in harsh environments at room temperature and at elevated temperatures show relatively better etch resistance compared to comparative samples.

### Example 3

### Additional Material Compositions

Samples 11-20 are prepared by mixing oxide powders at the ratios listed in Table 6. Half of each mixture is then sintered under pressure to form a sintered article, and the other half of each mixture is heated to melting and then poured into a ceramic mold and cooled.

TABLE 6
Ratio of oxides used to meet molar ratios.

| Sample # | Y₂O₃ | CeO₂ | Gd₂O₃ | Al₂O₃ | SiO₂ | total |
|---|---|---|---|---|---|---|
| 11 | 20 | 10 | — | 20 | 50 | 100 |
| 12 | 20 | — | 10 | 20 | 50 | 100 |
| 13 | 10 | 10 | — | 25 | 55 | 100 |
| 14 | 10 | — | 10 | 25 | 55 | 100 |
| 15 | 5 | 10 | 15 | 20 | 50 | 100 |
| 16 | 5 | 15 | 10 | 20 | 50 | 100 |
| 17 | — | 10 | 20 | 20 | 50 | 100 |
| 18 | — | 20 | 10 | 20 | 50 | 100 |
| 19 | — | 15 | — | 25 | 60 | 100 |
| 20 | 45 | — | — | 25 | 35 | 100 |

*Y = yttrium, Gd = gadolinium, Ce = cerium, Al = aluminum, Si = silicon (cation at %).

Each of the samples 11-20 part A (sintered) and part B (molten) are formed into test pucks. Each puck is transparent with little or no visibly noticeable haze. The test pucks are exposed to fluorine gas at a temperature of 750 degrees Celsius for 1 hour.

The embodiments described herein are examples of compositions, structures, systems, and methods having elements corresponding to the elements of the invention recited in the claims. This written description may enable those of ordinary skill in the art to make and use embodiments having alternative elements that likewise correspond to the elements of the invention recited in the claims. The scope of the invention thus includes compositions, structures, systems and methods that do not differ from the literal language of the claims, and further includes other structures, systems and methods with insubstantial differences from the literal language of the claims. While only certain features and embodiments have been illustrated and described herein, many modifications and changes may occur to one of ordinary skill in the relevant art. The appended claims cover all such modifications and changes.

What is claimed is:

1. A wafer processing apparatus, comprising:
a coating layer; and
a seal structure in contact with the coating layer, wherein the seal structure is formed from a seal formable material comprising at least one of a YASB glassy composition, an CGYP glassy composition, or a combination of the YASB glassy composition and the CGYP glassy composition.

2. The wafer processing apparatus as defined in claim 1, wherein the YASB glassy composition comprises the reaction product of yttrium oxide, aluminum oxide, boron oxide, and silica.

3. The wafer processing apparatus as defined in claim 2, wherein the YASB glassy composition comprises a material having a molar oxide percentage selected from the group consisting of Y₂Al₂BSi₅O_{17.5}; Y_{1.6}Al_{2.2}BSi_{5.2}O_{17.6}; YAl₂BSi₆O₁₈; Y_{0.6}Al_{2.2}BSi_{6.2}O_{18.1}; Y₂AlBSi₆O₁₈; and Y_{1.6}Al_{1.2}BSi_{6.2}O_{18.1}.

4. The wafer processing apparatus as defined in claim 1, wherein the CGYP glassy composition comprises the reaction product of at least one of calcium oxide or strontium oxide; and at least one of gallium oxide or aluminum oxide or yttrium oxide; and ammonium phosphate; and silica.

5. The wafer processing apparatus as defined in claim 4, wherein the CGYP glassy composition comprises a material selected from the group consisting of CaSrGaAlP₂SiO₁₂; CaSrAlYP₂SiO₁₂; CaSrAl_{1.25}Y_{0.75}P₂SiO₁₂; Ca₂Ga₂P₂SiO₁₂; CaSrGa₂P₂SiO₁₂; CaSrAl₂P₂SiO₁₂; CaSrY₂P₂SiO₁₂; Ca₂Y₂P₂SiO₁₂; Ca₂AlYP₂SiO₁₂; and CaSrAl_{0.5}Y_{1.5}P₂SiO₁₂.

6. The wafer processing apparatus as defined in claim 1, wherein the combination of the YASB glassy composition and the CGYP glassy composition has a ratio of the YASB glassy composition to the CGYP glassy composition is in a range of from about 0.05:1 to about 500:1.

7. The wafer processing apparatus as defined in claim 1, wherein the seal formable material has a softening temperature that is in a range of 650 degrees Celsius to 1000 degrees Celsius as measured by a dilatometer at a pressure of about 60 centiNewtons on an area of about 6 millimeters square to about 15 millimeters square.

8. The wafer processing apparatus as defined in claim 1, wherein the seal formable material has a melt temperature that is less than a melt temperature of the coating layer.

9. The wafer processing apparatus as defined in claim 1, wherein the seal formable material has a coefficient of thermal expansion that is in a range of from about 4 to about 10.

10. The wafer processing apparatus as defined in claim 9, wherein the seal formable material has a coefficient of thermal expansion that is in a range of from about 4.4 to about 5.7.

11. The wafer processing apparatus as defined in claim 9, wherein the seal formable material has a coefficient of thermal expansion that is about 6.

12. The wafer processing apparatus as defined in claim 1, wherein the seal formable material is a slurry or is a powder.

13. The wafer processing apparatus as defined in claim 1, wherein the seal formable material has an etch rate of less than 6 Angstroms/minute at 18 percent oxygen and the balance being CF₄ plasma at room temperature for 12 hours.

14. The wafer processing apparatus as defined in claim 1, wherein the seal formable material has an etch rate of less than 6 A/min in an environment comprising a plasma mixture of NF₃ (14.29%) and Ar (42.86%) and N₂ (42.86%) at 400 degrees Celsius for 60 minutes.

15. The wafer processing apparatus as defined in claim 1, wherein coating layer is disposed on a surface of a substrate, wherein the substrate comprises at least one of pyrolitic boron nitride, aluminum nitride, quartz or doped quartz, a metal or metal alloy, or another glassy composition.

16. The wafer processing apparatus as defined in claim 15, wherein the glassy composition is substantially the same as the seal formable material but has a relatively higher melt temperature.

17. The wafer processing apparatus as defined in claim 1, wherein the seal structure forms a glass-to-glass seal to the coating layer having an adhesive strength that is greater than about 300 psi.

18. The wafer processing apparatus as defined in claim 1, wherein the seal structure defines and seals an aperture through which an electrode or an electrical lead is disposed.

19. The wafer processing r apparatus as defined in claim 18, wherein the electrode is a heater element, an electrostatic chuck, or a thermocouple; and
the seal structure is bonded to an outer surface of the electrode to seal thereto.

20. The wafer processing apparatus as defined in claim 19, wherein the heater element is nickel-plated molybdenum.

21. The wafer processing apparatus as defined in claim 20, wherein the electrode is one of a plurality of electrodes, at least two of the electrodes are heater elements, and each of the heater elements defines a controllable heat zone that is proximate to the heater apparatus.

22. A method, comprising:
forming a seal structure on a coating layer of a wafer processing apparatus from a seal formable material, wherein the seal formable material comprises at least one of a YASB glassy composition, a CGYP glassy composition, or a combination of the YASB glassy composition and the CGYP glassy composition.

23. The method as defined in claim 22, wherein forming comprises flowing a slurry into contact with at least a portion of a heater, wherein the slurry comprises the seal formable material.

24. The method as defined in claim 22, where in forming comprises plasma deposition of the seal formable material.

25. The method as defined in claim 22, where in forming comprises contacting powder to at least a portion of a heater, and melting, softening or sintering the powder, wherein the powder comprises the seal formable material.

26. A heat generating device, comprising:
a heating element substrate;
a coating layer disposed on a surface of the substrate, and
means for sealing the coating layer to reduce etching of the substrate during operation, during cleaning, or during both operation and cleaning.
